(19) United States
(12) Patent Application Publication
(10) Pub. No.: US 2016/0078232 A1
(43) Pub. Date: Mar. 17, 2016

(54) COMPUTING DEVICE AND METHOD FOR ACCESSING FILES

(71) Applicant: Chiun Mai Communication Systems, Inc., New Taipei (TW)

(72) Inventor: TZAN-FU WANG, New Taipei (TW)

(21) Appl. No.: 14/686,270

(22) Filed: Apr. 14, 2015

(30) Foreign Application Priority Data
Sep. 15, 2014 (CN) 201410468459.4

(51) Int. Cl. G06F 21/60; H04L 9/14; H04W 12/08; H04L 29/06

(52) U.S. Cl. CPC G06F 21/602; H04L 63/102; H04L 9/14; H04W 12/08

(57) ABSTRACT

A method for accessing files in a computing device includes presetting authorized electronic devices. When an electronic device is detected to be within a range of a wireless device of the computing device and an access request is received from the electronic device, the computing device determines whether the electronic device is authorized. When the electronic device is authorized, a user of the electronic device is allowed to access the computing device. When the electronic device is not authorized, the user is denied access to the computing device.

### CROSS-REFERENCE TO RELATED APPLICATIONS

This application claims priority to Chinese Patent Application No. 201410468459.4 filed on Sep. 15, 2014, the contents of which are incorporated by reference herein.

### FIELD

The subject matter herein generally relates to data security technology, and particularly to a computing device and a method for accessing files in the computing device.

### BACKGROUND

A computing device (e.g., a server or a computer) storing a mass of files can be connected to plurality of electronic devices (e.g., smart phones, tablet computers, or personal digital assistants). It is important to ensure security of data of the files stored in the computing device when the computing device receives requests from a user to access the files.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of an example embodiment of a computing device including a file accessing system.

FIG. 2 is a block diagram of an example embodiment of function modules of the file accessing system in the computing device of FIG. 1.

FIG. 3 is a flowchart of an example embodiment of a file accessing method in the computing device of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. It should be noted that references to “an” or “one” embodiment in this disclosure are not necessarily to the same embodiment, and such references mean “at least one.”

The term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY™, flash memory, and hard disk drives.

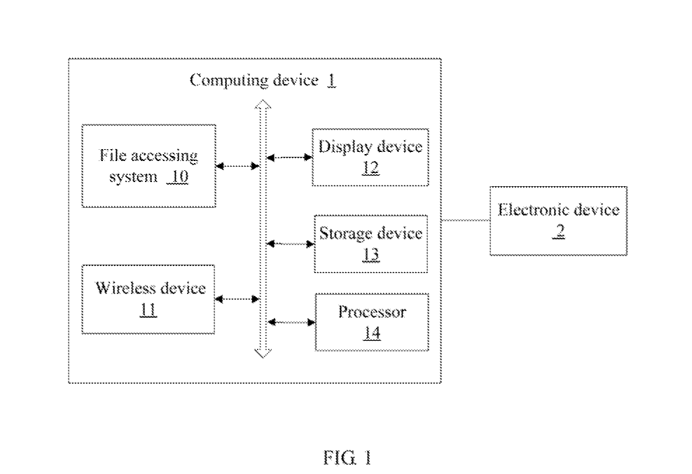

FIG. 1 is a block diagram of an example embodiment of a computing device. In at least one embodiment as shown in FIG. 1, a computing device 1 includes a file accessing system 10, the computing device 1 can be a sever, a personal digital assistant (PDA), a tablet computer, or other computing device. The computing device 1 further includes, but is not limited to, a wireless device 11, a display device 12, a storage device 13, and at least one processor 14. FIG. 1 illustrates only one example of the computing device, other examples can include more or fewer components than illustrated, or have a different configuration of the various components in other embodiments.

The wireless device 11 may broadcast signals that can be received by an electronic device 2 (e.g., a smart phone). When the electronic device 2 is within a range of the wireless device 11, the wireless device 11 can recognize the electronic device 2, and establish a wireless connection between the computing device 1 and the electronic device 2, and interact with the electronic device 2, such as to exchange data between the computing device 1 and the electronic device 2.

In at least one embodiment, the storage device 13 can include various types of non-transitory computer-readable storage mediums. For example, the storage device 13 can be an internal storage system, such as a flash memory, a random access memory (RAM) for temporary storage of information, and/or a read-only memory (ROM) for permanent storage of information. The storage device 13 can also be an external storage system, such as a hard disk, a storage card, or a data storage medium. The at least one processor 14 can be a central processing unit (CPU), a microprocessor, or other data processor chip that performs functions of the computing device 1.

The file accessing system 10 can allow a user of an electronic device 2 to access files in a computing device 1 when the electronic device 2 is detected to be authorized.

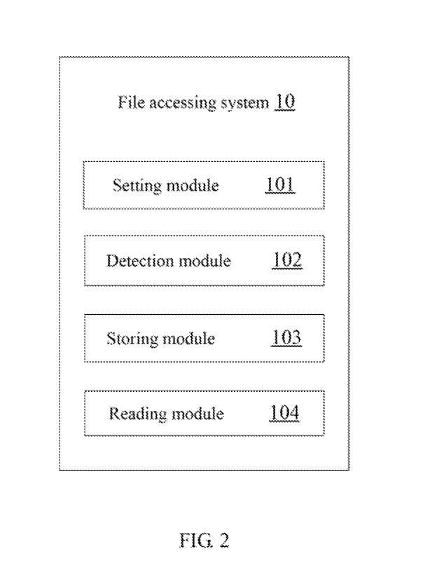

FIG. 2 is a block diagram of one embodiment of function modules of the file accessing system. In at least one embodiment, the file accessing system 10 includes a setting module 101, a detection module 102, a storing module 103, and a reading module 104. The function modules 101, 102, 103 and 104 can include computerized codes in the form of one or more programs, which are stored in the storage device 13. The at least one processor 14 executes the computerized codes to provide functions of the function modules 101-104.

The setting module 101 presets a plurality of authorized electronic devices of the computing device 1. In at least one embodiment, the authorized electronic devices can be smart phones, personal digital assistants (PDAs), tablet computers, or other electronic devices. The setting module 101 can bind the authorized electronic devices to the wireless device 11 of the computing device 1 by storing a verification code of the authorized electronic devices and a device code of the wireless device 11 into the storage device 13. For example, when the authorized electronic device is a cell phone, the verification code of the authorized electronic device is International Mobile Equipment Identity (IMEI), the setting module 101 binds the cell phone and the wireless device 11 by relating and storing the IMEI of the cell phone and the device code of the wireless device 11.

The detection module 102 detects whether an electronic device 2 is within a range of the computing device 1. In at least one embodiment, the electronic device 2 is determined to be within the range of the computing device 1 using a wireless device 11 of the computing device 1. The wireless device 11 may broadcast signals to different electronic devices 2 within the range. The detection module 102 detects whether the wireless device 11 is connected to the electronic device 2. When the wireless device 11 is connected to the electronic device 2, the detection module 102 determines that the electronic device 2 is within the range of the computing device 1. When the wireless device 11 is not connected to the electronic device 2, the detection module 102 determines that no electronic device 2 is within the range of the computing device 1.

In some embodiments, in response to receiving an access request from the electronic device 2, the detection module 102 determines whether the electronic device 2 is authorized, when the electronic device 2 is within range of the computing device 1. In some embodiments, the access request includes a first access request to store a file into the storage device 13, and a second access request to read the file from the storage device 13.

In other embodiments, no matter what access request is received, the detection module 102 determines whether the electronic device 2 is authorized when the electronic device 2 is within the range of the computing device 1.

In at least one embodiment, the detection module 102 determines whether a verification code of the electronic device 2 is a stored verification code in the storage device 13. When the verification code of the electronic device 2 is one of the stored verification code in the storage device 13, the detection module 102 determines the electronic device 2 is authorized. When the verification code of the electronic device 2 is not any one of the stored verification code in the storage device 13, the detection module 102 determines the electronic device 2 is not authorized.

When the electronic device 2 is authorized, the computing device 1 allows the user to access the computing device 1. When the electronic device 2 is not authorized, the computing device 1 denies the user access to the computing device 1.

As mentioned above, the access request includes the first access request and the second access request. The access request can be input from the computing device 1 directly, or received from the electronic device 2. When the storing module 103 receives the first access request from the user to store a first file into the storage device 13, the storing module 103 stores the first file into the storage device 13. In some embodiments, the first file may be received from the electronic device 2, or be downloaded from a network. The storing module 103 encrypts the first file using preset encryption algorithms after receiving the first access request and the first file, and stores the encrypted first file into the storage device 13. In at least one embodiment, the encryption algorithms include a symmetric encryption algorithm and an asymmetric encryption algorithm. For example, the symmetric encryption algorithm may be a Data Encryption Standard (DES) algorithm, and the asymmetric encryption algorithm may be a Rivest Shamir Adleman (RSA) encryption algorithm.

When the reading module 104 receives the second access request from the user to read a second file from the computing device 1, the reading module 104 decrypts the second file using preset decryption algorithms, and outputs the decrypted second file on the display device 12 of the computing device 1. In at least one embodiment, the decryption algorithms include a symmetric decryption algorithm and an asymmetric decryption algorithm. For example, the symmetric decryption algorithm may be a Data Decryption Standard (DDS) algorithm, the asymmetric decryption algorithm may be a RSA decryption algorithm. The first file and the second file can be a same file or different files.

By utilizing the file accessing system 10, an identity of the user can be verified by connecting the electronic device 2 to the computing device 1 through the wireless device 11. When the electronic device 2 is determined to be authorized, the user can access and manage files in the storage device 13.

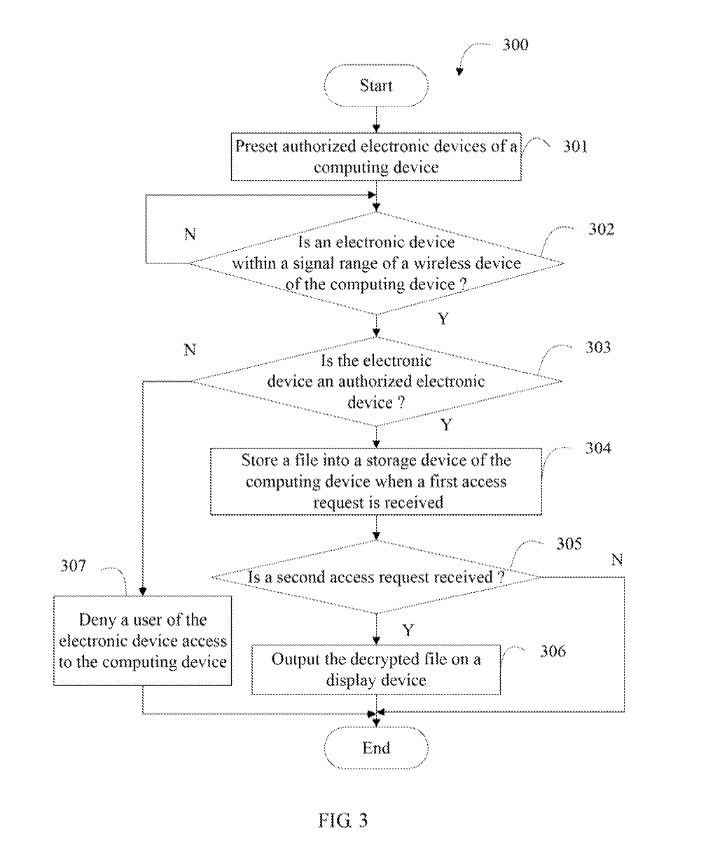

FIG. 3 illustrates a flowchart of an example embodiment of a method for accessing files of the computing device of FIG. 1. In at least one embodiment, a example method 300 is provided by way of example, as there are a variety of ways to carry out the method. The example method 300 described below can be carried out using the configurations illustrated in FIG. 1, for example, and various elements of these figures are referenced in explaining example method 300. Each block shown in FIG. 3 represents one or more processes, methods, or subroutines, carried out in the example method 300. Furthermore, the illustrated order of blocks is by example only and the order of the blocks can change according to the present disclosure. The example method 300 can begin at block 301. Depending on the embodiment, additional steps can be added, others removed, and the ordering of the steps can be changed.

At block 301, a setting module presets at least one authorized electronic device of the computing device 1. In at least one embodiment, the authorized electronic devices can be smart phones, personal digital assistants (PDAs), tablet computers, or other electronic devices. The setting module can bind the authorized electronic devices to the wireless device 11 of the computing device 1 by storing a verification code of the authorized electronic devices and a device code of the wireless device 11 into the storage device 13.

At block 302, a detection module detects whether an electronic device 2 is within a range of the computing device 1. When the electronic device 2 is within the range of the computing device 1, the procedure goes to block 303. When no electronic device 2 is within the range of the computing device 1, the block 302 is repeated.

At block 303, the detection module determines whether the electronic device 2 is authorized. When the electronic device 2 is authorized, the procedure goes to block 304. When the electronic device 2 is not authorized, the procedure goes to block 307. In at least one embodiment, the detection module detects whether a verification code of the electronic device 2 is a stored verification code in the storage device 13. When the verification code of the electronic device 2 is a stored verification code, the electronic device 2 is determined to be authorized. When the verification code of the electronic device 2 is not a stored verification code, the electronic device 2 is determined to be not authorized.

At block 304, a storing module stores a file into the storage device 13 of the computing device 1 when a first access request is received from a user of the electronic device 2. In at least one embodiment, the storing module encrypts the file using preset encryption algorithms after receiving the first access request and the file, and stores the encrypted file into the storage device 13. In at least one embodiment, the encryption algorithms include a symmetric encryption algorithm and an asymmetric encryption algorithm. For example, the symmetric encryption algorithm may be a Data Encryption Standard (DES) algorithm, and the asymmetric encryption algorithm may be a RSA encryption algorithm.

At block 305, the detection module detects whether a second access request from the user is received. When the second access request from the user is received, the procedure goes to block 306. When no second access request is received, the procedure ends.

At block 306, a reading module outputs the file on the display device 12 of the computing device 1. In at least one embodiment, the reading module decrypts the file using preset decryption algorithms, and outputs the decrypted file on the display device 12 of the computing device 1. The encryption algorithms include a symmetric decryption algorithm and an asymmetric decryption algorithm. For example, the symmetric decryption algorithm may be a Data Decryption Standard (DDS) algorithm, the asymmetric decryption algorithm may be a RSA decryption algorithm.

At block 307, the reading module denies the user of the electronic device 2 access to the computing device 1. In at least one embodiment, the reading module denies the user access to store files into the storage device 13, or read files from the storage device 13 when the electronic device 2 is determined to be un-authorized.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. A computing device comprising:
at least one processor; and
a storage device that stores one or more programs which, when executed by the at least one processor, cause the at least one processor to:
preset at least one authorized electronic device;
receive an access request from an electronic device within a range of the computing device;
allow a user of the electronic device to access the computing device when the electronic device is authorized; and
deny the user of the electronic device access to the computing device when the electronic device is not authorized.

2. The computing device according to claim 1, wherein the at least one processor further:
encrypts a file using preset encryption algorithms when the access request is to store the file into the storage device of the computing device; and
stores the encrypted file into the storage device.

3. The computing device according to claim 2, wherein the encryption algorithms comprise a symmetric encryption algorithm and an asymmetric encryption algorithm.

4. The computing device according to claim 1, wherein the at least one processor further:
decrypts the file using preset decryption algorithms when the access request is to read a file from the storage device; and
outputs the decrypted file on a display device of the computing device.

5. The computing device according to claim 1, wherein the electronic device is determined to be within the range of the computing device using a wireless device of the computing device.

6. The computing device according to claim 1, wherein each of the authorized electronic devices is preset by storing a verification code of the authorized electronic devices into the storage device.

7. A computer-implemented method for accessing files in a computing device being executed by at least one processor of the computing device, the computing device comprising a storage device, the method comprising:
presetting at least one authorized electronic device;
receiving an access request from an electronic device within a range of the computing device;
allowing a user of the electronic device to access the computing device when the electronic device is authorized; and
denying the user of the electronic device access to the computing device when the electronic device is not authorized.

8. The method according to claim 7, further comprising:
encrypting a file using preset encryption algorithms when the access request is to store the file into the storage device of the computing device; and
storing the encrypted file into the storage device.

9. The method according to claim 8, wherein the encryption algorithms comprise a symmetric encryption algorithm and an asymmetric encryption algorithm.

10. The method according to claim 7, further comprising:
decrypting a file using preset decryption algorithms when the access request is to read the file from the storage device; and
outputting the decrypted file on a display device of the computing device.

11. The method according to claim 7, wherein the electronic device is determined to be within the range of the computing device using a wireless device of the computing device.

12. The method according to claim 7, wherein each of the authorized electronic devices is preset by storing a verification code of the authorized electronic devices.

13. A non-transitory storage medium having stored thereon instructions that, when executed by a processor of a computing device, causes the processor to perform a method for accessing files, the method comprising:
presetting at least one authorized electronic device;
receiving an access request from an electronic device within a range of the computing device;
allowing a user of the electronic device to access the computing device when the electronic device is authorized; and
denying the user of the electronic device access to the computing device when the electronic device is not authorized.

14. The non-transitory storage medium according to claim 13, wherein the method further comprises:
encrypting a file using preset encryption algorithms when the access request is to store the file into the storage device of the computing device; and
storing the encrypted file into the storage device.

15. The non-transitory storage medium according to claim 14, wherein the encryption algorithms comprise a symmetric encryption algorithm and an asymmetric encryption algorithm.

16. The non-transitory storage medium according to claim 13, wherein the method further comprises:
decrypting a file using preset decryption algorithms when the access request is to read the file from the storage device; and
outputting the decrypted file on a display device of the computing device.

17. The non-transitory storage medium according to claim 13, wherein the electronic device is determined to be within the range of the computing device using a wireless device of the computing device.

18. The non-transitory storage medium according to claim 13, wherein each of the authorized electronic devices is preset by storing a verification code of the authorized electronic devices.
